(19) United States
(12) Patent Application Publication
(10) Pub. No.: US 2008/0084587 A1
(43) Pub. Date: Apr. 10, 2008

(54) Image reading device

(75) Inventor: Yoshifumi Noguchi, Kawasaki-shi (JP)

Correspondence Address: OLIFF & BERRIDGE, PLC, P.O. BOX 320850, ALEXANDRIA, VA, 22320-4850, US

(73) Assignee: RISO KAGAKU CORPORATION, TOKYO (JP)

(21) Appl. No.: 11/905,467

(22) Filed: Oct. 1, 2007

(30) Foreign Application Priority Data
Oct. 4, 2006 (JP) 2006-273072

(51) Int. Cl. H04N 1/393

(52) U.S. Cl. 358/451

(57) ABSTRACT

There is provided an image reading device directly connected to a printer and modifying an image data to print an image in a size and/or with a layout desired by a user, wherein, after the information for the modification has been obtained once, no acquisition of the information for the modification is required. The inventive device comprises an image data output portion for outputting an image data with a communication system which enables a printer supporting a communication standard to print the image directly received from the output portion, a printer identifying portion for identifying the printer and a modification data storage portion for storing the modification data associated with an identifiable printer and used in modifying the image data to be transmitted to the printer.

### BACKGROUND OF THE INVENTION

1. Field of the Invention

The present invention relates to an image reading device which reads an image drawn on a paper sheet, a plastic sheet, cloth or other media, and generates and outputs an image data thereof. More specifically, the present invention relates to an image reading device which is designed so as to transmit an image data directly to a printer, enabling the printer to print an image without intermediation of a personal computer (PC). In the following, an “image data” means a data representing an image. Further, an image of an original copy is referred to as an “original image”, and an image printed on a medium such as a paper sheet, a plastic sheet, cloth (called “printing medium” hereinbelow) is referred to as a “printed image”.

2. Description of the Prior Art

According to a wide spread of PCs, an image reading device, such as an image scanner, has now become popular to be handily used at low cost in homes or offices. When an image reading device and a printer are connected with a PC, an image on a paper sheet or other media can be easily acquired into the PC as an electronized image data and duplicated or printed on a printing medium, and thereby, anyone has become able to relatively easily produce various printed matters, such as New Year's cards, season greetings, Christmas cards, handbills, flyers, in his home or office. Moreover, according to the technological development of image sensors in image reading devices and ink-jet systems in printers, images printed with a printer based upon an image data generated through the reading of an image with an image reading device are qualitatively comparable with a film photo.

In the duplication and printing of images using a PC together with an image reading device and a printer, the whole processes are executed under the control of the PC, and therefore it is required to prepare and operate an appropriate PC. However, as compared with image reading devices and printers, PCs are expensive and the operation thereof may be often troublesome. Thus, in Japanese Patent Laid-open publications Nos. JP 2004-104665, 2005-22307, 2005-22836, 2005-27140 and 2005-27141, filed by the same assignee of the present application, there have been proposed an image reading and printing system comprising an image reading device and a printer (a postcard preparing apparatus), wherein, without a PC, an image is read with the image reading device, and directly outputted to the printer and printed therewith. In such an image reading and printing system, the reading of an image in a drawing or a manuscript prepared by handwriting and/or patching, etc. with the image reading device and the printing of a duplicated copy of the image are conducted only through simple or easy button operation, so that not only the system is far less expensive than when a PC is used, but also even the generation, not familiar with PCs, or children can relatively easily enjoy the duplication and printing of New year's cards, postcards, invitation cards for a birthday party or a Christmas party, etc.

By the way, in the market of PCs for household and office use, many manufacturers have manufactured and sold various types and models of PCs, image reading devices and printers as peripheral equipment for PCs. From those various PCs and/or peripheral equipment, consumers can choose favorite ones, while taking into account the performances, prices, etc. thereof. Since communication systems or modes, equipped on those PCs and peripheral equipment for establishing mutual communication between them, are designed to follow or support a predetermined communication standard, it is possible to use a scanner of company B and a printer of company C by connecting them to a PC of company A. Especially for communication between printers and digital cameras, there is proposed a communication standard, such as Pictbridge, enabling the printing of an image data of a predetermined image format only by transmitting the data from a digital camera to a printer. Thus, a photograph captured with a camera supporting a mode of such a communication standard can be printed with any printers supporting a mode of the common communication standard without using a PC. Accordingly, if an image reading and printing system, such as postcard preparing apparatus, as mentioned above, is equipped with a communication system of such a predetermined communication standard that enables the printing of an image through direct transmission of an image data to a printer, an arbitrary printer supporting the common predetermined communication standard could be used.

However, even if a communication system of such a predetermined communication standard as described above is employed in an image reading device, an image is not always printed on a printing medium in a manner expected by a user.

A digitized image data, usually, is a set of pixels each having coordinate data and a brightness value in a monochrome image or brightness values for color components, e.g. R, G, B in a color image. Thus, when an image data is transmitted to a printer, it is required for printing an image corresponding to the image data to specify the number of pixels deposited on a printing medium per unit length (in other words, the size of the area on the printing medium to which an individual pixel in the image data is allocated) or the size of the image on the printing medium. In this regard, in most of printers supporting a communication standard such as PictBridge designed mainly for printing photograph images taken with a digital camera, the number of pixels per unit length or the size of an image on a printing medium is automatically determined in the individual printers, and can not be changed or adjusted by a user. In particular, when so-called “margin-less printing”, namely, a mode in which an image is printed on the whole surface of a printing medium without margin, is executed in a printer as described above to print an image through the direct reception of an image data from a digital camera, etc., the image corresponding to an image data received in the printer is set to be a little larger in size than a printing medium, namely, the edges of the printed image corresponding to the received image data extend out of the printing medium, as shown in the upper right drawing in FIG. 9 (See e.g. JP 2003-274155). Accordingly, in “margin-less printing”, if an image data as it is just prepared by reading an original image with an image reading device is transmitted to a printer, the periphery of the original image is cut away from the resultant printed image, and, if the printing medium has the same size as the original drawing, the printed image will be magnified relative to the original image (see the lower in FIG. 9). However, a user cannot adjust the width and direction of peripheral portions of the image extending beyond the edge of the printing medium, or, the size and position of the region to be printed on the printing medium in the image data transmitted to the printer [It is possible that the center of a transmitted image data always deviates form the center of a printing medium due to errors in size of a printing medium, in feeding a printing medium in a printer.]. Further, the width and direction of periphery portions of an image extending beyond the edge of a printing medium vary with models of printers. Thus, due to an automatic determination of the size of an image on a printing medium in accordance with the internal setting of a printer as described above, the resultant printed image on a printing medium is not always expected by a user.

Then, in order to solve the above-mentioned problem, there has been proposed in Japanese Patent Application 2006-178606, filed by the same person as the assignee of the present application, an image reading device which enables a printer, directly connected thereto, to print an image, which has been read in with the image reading device, on a printing medium in a size and/or with a layout intended by a user irrespective of any automatic internal setting function of the connected printer. The image reading device described in that patent application comprises an image detecting portion and an image data generating portion for reading images and generating an image data, as provided in a conventional image reading devices, and further comprises an image data output portion for outputting an image data with a communication mode which enables a printer supporting a predetermined communication standard, such as “PictBridge”, to receive the image data and to print an image corresponding to the received data, and an image modification processing portion which, prior to the outputting of the image data from the data output portion, modifies the image data based upon “an image data for modification” having been prepared in advance.

In the device of the above-mentioned patent application, the “image data for modification” prepared for the modification of an image data is a data obtained by outputting a reference image data representing a reference image including a predetermined pattern from the image data outputting portion to a printer to be used; by reading, with the image detecting portion, the resultant image printed on a printing medium with the printer based upon the outputted reference image data; and by generating the data (image data for modification) with the image data generating portion based upon the read image. The printed image of the reference image, the basis of the image data for modification, contains information with regard to “how a printer connected to the image reading device prints the received image data”, and therefore, through the analysis of the image data for modification generated from the printed image of a reference image, one can acquire the information of the size and position of the region actually printed on a print medium within an image data transmitted to a printer (An actually printed region in an image data is referred to as a “print region” of an image data hereinbelow.); the information of the size and position of a transmitted image data upon its printing; the information of the widths of the peripheral portions in a transmitted image data which will be cut off upon its printing, etc. Then, from such information, there will be known the size and position of “an image to be printed” at allocating or assigning it within a transmitted image data in order to obtain a printed image on a printing medium as expected by a user.

Thus, according to the invention of the above-mentioned patent application, an image can be printed in a desired size or with a desired layout on a printing medium with an arbitrary printer, by obtaining beforehand the information of the size or position of a “print region” in an image data transmitted to the printer when it is used, and by modifying an image data read with the image reading device based upon the information before the transmission of the image data to the printer. In modifying an image data transmitted to a printer, parameters for modification such as “scaling factor” and “shifting amount” computed from an image data for modification are used.

### SUMMARY OF THE INVENTION

In a printer setting up the number of pixels per unit length or the image size on a printing medium by itself as described above, the size and position of a print region and the width of the cut-off peripheral portions in an image data transmitted to the printer are fixed and do not vary by each time of connection of the printer to the image reading device. It has been found also that, for printers of the same model, usually, the sizes and positions of print regions and the widths of the cut-off peripheral portions are not changed. Namely, the information required for the modification of an image in the printing such as an image data for modification or parameters used for the modification of an image derived from the image data for modification, once obtained for each printer or each model of printers, can be used in the subsequent printing for the same printer or the same model thereof as long as the internal setting of the printer in its printing operation are not substantially changed. Thus, if the image reading device which modifies the size or position of an image as described in the above-mentioned patent application is designed such that no operation for obtaining the information for the modification of an image is required for the printer or the models thereof of which the information used for the modification of an image has been obtained once, the burden of operation on the user of the image reading device will be much lessened.

Accordingly, it is an object of the present invention to provide an image reading device of the type of directly transmitting an image data to a printer and being designed so as to modify the image data to be printed prior to its transmission so that the image can be printed in a desired size or with a desired layout on a printing medium, wherein no repetitive operation of obtaining the information required for the modification of an image data is needed for a printer or a model of which the information has been already obtained.

In general, the image reading device according to the present invention comprises an image detecting portion which optically reads an image of an original copy and generates a signal representing the original image, an image data generating portion which generates an original image data based upon the signal representing the original image, and an image data outputting portion which outputs an image data with a communication mode which enables a printer supporting, or being adapted for, a predetermined communication standard to receive the image data and to print an image represented by the image data, whereby the printing of the read image can be performed with an arbitrary printer supporting the communication mode of the image data outputting portion without using a PC, and for its characterizing structures, further comprises a printer identifying portion, a modification data storage portion and an image modification processing portion.

In the above-mentioned structure, the printer identifying portion is a portion for identifying a printer being set capable of receiving an image data from the image data output portion, i.e. a printer connected to the image data output portion with any cable communication system or a printer of which a communication with the image data outputting portion has been established with any wireless communication system. Accordingly, the inventive device is designed to identify and specify a printer when the printer is set capable of receiving an image data from the image data outputting portion. The modification data storage portion in the above-mentioned structure is a portion for storing modification data, e.g. at least one set of parameters used for modifying the original image data, while associated with at least one printer. In this respect, an individual “modification data” is a data or a set of parameters prepared for an individual printer based upon the size and/or position of an image in an image data received by the corresponding printer and printed on a printing medium with the corresponding printer. Thus, the individual modification data stored in this modification data storage portion is associated with a printer identifiable by the printer identifying portion.

And, the image modification processing portion in the above-mentioned structure is a portion for selectively modifying an original image data based upon the modification data stored in the modification data storage portion while being associated with a printer identified by the printer identifying portion. As noted, an individual modification data (a set of parameters used for the modification of an original image) is prepared for a certain printer based upon the size and/or position of an image printed on a printing medium in an image data received by the printer, so that the modification data reflects the internal settings of the printer regarding the print region actually printed on a printing medium of an image data received by the printer, or the size (number of pixels per unit length) or position of the image in the printing of the received image data, etc. Thus, when a printer is identified by the printer identifying portion, the image modification processing portion draws out from the modification data storage portion the modification data associated with the corresponding printer, modifies an original image data based upon the modification data (i.e. based upon the information of the internal setting of the printer) to generate a modified original image data so as to render a printed image corresponding to the original image to be produced in a desired size and/or with a desired layout on a printing medium, and outputs the modified original image data through the image data outputting portion.

Accordingly, in the above-mentioned structure of the present invention, for a printer of which the modification data is stored in the modification data storage portion, it is possible to print a printed image corresponding to an original image in a desired size and/or with a desired layout on a printing medium without the operation of obtaining the modification data, thereby lessening the user's burden for printing operation.

In order to identify a printer which is set capable of receiving an image data from the image data outputting portion, the printer identifying portion as described above may be so constructed as to obtain the information of the printer from the communication between the printer and the image data outputting portion. In a printer supporting the communication standards such as “PickBridge”, for instance, its vendor name, vendor's version, machine name, machine number, etc. are prepared for the identifying information of the printer, which identifying information is available from an output from the communication control portion or communication control device of the printer. Accordingly, a device having been set up to be able to communicate with such a printer can obtain such identifying information as mentioned above with the communication through the communication control portion of the printer. Thus, the printer identifying portion of the inventive image reading device may be so designed as to identify a printer with the identifying information thereof available from the communication with the printer. Alternatively, regardless of the availability of the identifying information of a printer from the communication with the printer, a means for obtaining the information for identifying a printer through a manual operation of a user may be provided in the image reading device for entering the identifying information of the connected printer to the image reading device.

In the identification of printers in an embodiment, typically, each printer may be identified in accordance with its model. As already noted, for the commercially available printers, in general, the size and position of the print region and the width of the cut-off peripheral portions in an image data transmitted to each printer in its printing operation are determined according to the model of the printer. Accordingly, when a certain image data is transmitted to printers of the same model, the sizes and positions of the print region and the widths of the cut-off peripheral portions in the image data are identical, and therefore, for the printers of the same model, the same modification data can be used. Thus, for a certain printer connected to or communicable with the image reading device, typically, the modification of an original image data for obtaining a printed image in a desired size and/or with a desired layout on a printing medium can be done by identifying the model of that printer and using the modification data associated with the model. However, it is possible that the sizes of printed images or the widths of the cut-off peripheral portions of an image data transmitted to printers of the same model are different among the printers, and therefore, each printer may be identified by the production number or serial number particular to the printer.

Further, in order to obtain modification data to be stored in the modification data storage portion for use in modifying an original image data for a printer, the inventive image reading device may be so designed as to prepare a modification data by itself for a printer set capable of receiving an image data from the image reading device. For the preparation of modification data, the image data reading device may be provided with a modification data preparing portion. The modification data preparing portion outputs a reference image data representing a reference image from the image data outputting portion to a printer set capable of receiving an image data, and prepares the modification data for the printer based upon “an image data for modification” generated in the image data generating portion from a signal obtained by reading the image printed with the printer on a printing medium by means of the image detecting portion. Then, the prepared modification data is stored in the modification data storage portion while being associated with the printer connected or rendered to be communicable at that time. According to this structure, when a certain printer is connected to the inventive image reading device and the modification data for the printer is once prepared as described above, no further preparation of the modification data is required in future use of the printer, lessening the burden of operation of the user.

In this connection, in some of printers, no identifying information of the printer is acquirable from the communication between the image reading device and the printer. For such a case, the modification data storage portion may have a modification data storage area associated with no particular printer so that the modification data not associated with any particular printers can be stored. According to this structure, if a printer is not identifiable by the printer identifying portion, the modification data prepared by the modification data preparing portion for the printer is stored in the modification data storage area associated with no particular printer, and the modification data associated with no particular printer may be always used for an unidentifiable printer. Accordingly, the provision of an area for storing the modification data associated with no particular printer enables the modification of an image data for printing an image as expected by a user even upon using an unidentifiable printer. Such a structure can be utilized in a case that, for example, a user of the image reading device uses only such a printer that have no identifying information or no function of outputting its identifying information.

Furthermore, in an alternative aspect of the present invention for acquisition of a modification data associated with a printer, the modification data storage portion of the inventive image reading device may be designed so as to store a modification data prepared for a printer at the outside of the image reading device (i.e. prepared with any device other than the image reading device), for example, by storing the modification data associated with a commercially available printer into the modification data storage portions in manufacturing or delivering the image reading device. In this case, when a printer of which the modification data has been stored is used with the inventive image reading device, a user need not execute the preparation for the modification data, lessening the burden of operation of the user. Furthermore, the inventive image reading device may be provided with a modification data receiving portion to receive a modification data prepared for a printer at the outside of the image reading device, and the modification data storage portion may be designed to be capable of storing the modification data prepared at the outside of the image reading device and received with the modification data receiving portion. According to this aspect, a user can advantageously add modification data to the image reading device without preparing the modification data after the manufacture or sale of the image reading device.

Still further, in the inventive image reading device, when the amount of the data stored in the modification data storage portion has exceeded a predetermined amount at storing new modification data, a part of the modification data already stored may be deleted. Then, even if the empty space in the storage portion is insufficient due to the presence of the accumulated modification data when a user starts to use a new printer, the new modification data associated with the new printer can be newly stored. In the deleting of a part of the modification data, preferably, the data to be deleted is, for example, the modification data associated with the printer of which the time of the last connection to the image reading device is the oldest among the printers of which the modification data are stored, or, the modification data associated with the printer of which the number of the frequencies of connection to the image reading device is the least among the modification data for printers of which the respective orders of the time of the last connection to the image reading device, counted from the oldest one, are within the number being at a predetermined ratio for the total number of all the stored data (the number given by multiplying the total data number by the predetermined ratio).

Moreover, in the modification data storage portion of the image reading device, an “initial modification data” associated with no particular printer may be stored so that the image modification processing portion can selectively modify an original image data based upon the initial modification data regardless of the identification of the printer by the printer identifying portion. The initial modification data may be set to adapt for the internal setting of a typical printer. In this case, the size or layout of the resultant printed image would be likely to be inconsistent with the result desired by the user. However, the result of the printing would be closer to the desire of the user than when no modification is made.

In addition, it should be understood that the inventive image reading device may selectively include the structures described in Japanese Patent Application 2006-178606 and that embodiments employing either of those structures as described therein belong to the scope of the present invention.

According to the inventive image reading device as described above, any printer supporting a predetermined or certain communication standard, supplied by various manufacturers, can be selected for a printer, as in using the image reading device described in Patent Application 2006-178606. In addition to such an advantage, according to the present invention, when a printer is rendered to be capable of receiving an image data from the image data output portion and identified or specified, the modification data associated with the identified printer is made ready for its use by taking it out from the modification date storage portion, and therefore the occasions requiring the operation of preparing the modification data are much decreased, thereby lessening the printing work of a user of using the image reading device. The feature that a modification data for modifying an image data can be selectively used in accordance with a printer in one image reading device is advantageous in such a case that a plurality of printers are selectively used in accordance with the qualities of printed images or the performances, such as the printing speed, printing cost, etc., of the respective printers.

Further, in the embodiment in which the inventive image reading device is provided with the modification data preparing portion, a modification data for a printer to be used for the printing of an image, even if not stored in advance in the storage portion, can be prepared and, thereafter, the modification of the image data can be executed without the preparing of the data. Also, in a case that the internal setting of a printer for its printing operation has changed due to an aging effect or any other causes, the modification of the image data without the preparing of the data becomes possible again by executing the operation of the preparation of the data of the printer each time its internal settings have varied, and accordingly, the printing of the original image in a size and/or with a layout desired by a user can be continued. Furthermore, in the embodiment in which the inventive image reading device is provided with the modification data receiving portion for receiving a new modification data, for example, when a new printer put into the market after the purchase of the image reading device is used for printing an image acquired with the image reading device, the modification of an original image data adapted for the new printer will be executed without the preparing operation of the modification data if the modification data associated with the new printer is obtained, thereby lessening the burden in operation of the user. New modification data may be distributed by the supplier of the image reading device.

Other objects and advantages of the present invention will become apparent from the following descriptions about the preferred embodiments of the present invention.

### BRIEF DESCRIPTION OF THE DRAWINGS

In the accompanying drawings,

FIG. 1A is a perspective view showing a preferred embodiment of an image reading device 1 according to the present invention, and FIG. 1B is a block diagram showing the internal structure of the image reading device 1;

FIG. 2A is a view showing the relationship of the sizes and positions between an image data transmitted to a printer and the print region therein; FIG. 2B is a view showing a modified original image data to be transmitted to a printer in which data an original image data is modified to conform to the print region; FIG. 2C is a view showing a modified original image data to be transmitted to a printer in which data an original image data is set to extend beyond the print region by a determined amount, i.e. the peripheral portions are cutoff in the printing of the image; and FIG. 2D is a view showing a modified original image data to be transmitted to a printer, in which data an original image data is rendered to be smaller than the print region by a determined amount, i.e. unfilled marginal portions are formed at the peripheral portions in the printing of the image;

FIG. 3A shows an example of a reference image and its printed image used for preparing the modification parameters, wherein a rectangular area is drawn in the reference image as co-centered, and FIG. 3B shows another example of a reference image and its printed image used for preparing modification parameters, wherein predetermined line elements are drawn at a predetermined spacing along the peripheral portions in the reference image;

FIG. 4 shows the flow of operation by a user and operations of image reading device 1 and printer 2 in the calibration mode of image reading device 1;

FIG. 5 diagrammatically shows the data structure of a parameter memory;

FIG. 6 shows the flow of operation by a user and operations of image reading device 1 and printer 2 in the normal mode of image reading device 1;

FIG. 7 is a flowchart showing the selection process of the modification parameters in the normal mode;

FIGS. 8A, 8B and 8C each show the manner of selecting modification parameters from the parameter memory according to the identifying information of a printer; and

FIG. 9 shows the condition that the peripheral portions of an image data are cut off in the printed image when a printer executes the margin-less printing.

### DESCRIPTION OF THE EMBODIMENTS

In the following, the present invention will be described in more detail in the form of some preferred embodiments by referring to the accompanying drawings. In the drawings, the same portions are designated by the same reference numerals.

### Structure of Image Reading Device

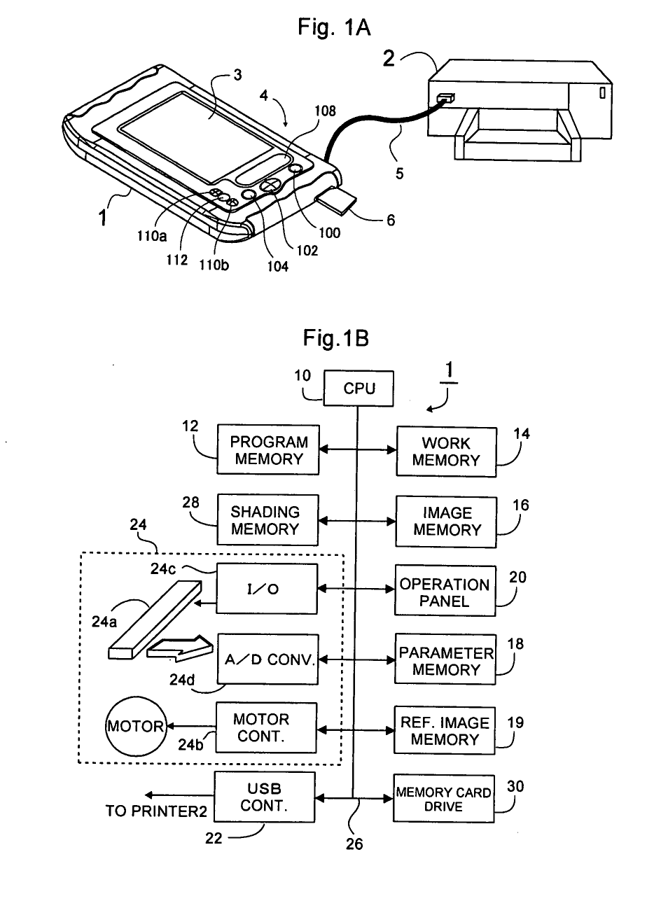

FIG. 1A shows a perspective view of one preferable embodiment of the inventive image reading device 1. The image reading device 1 may be, so called, an “image scanner”, i.e., a device which scans a paper sheet, a cloth sheet, a plastic sheet and other media, detects an original image drawn thereon optically (for example, by applying light on an object to be read to detect the reflected light from the object with a photon detection element or device, such as CCD), and converts the detected image information or signals into a digital data. The image reading device 1 may be of the type of a flat-bed scanner, in which an original image is positioned downwardly on a transparent board member, but, preferably, the image reading device 1 is a scanner of a type, as described in the reference publications described above, having a flat case whose top and bottom surfaces are formed with transparent board members (only the top surface 3 is shown in the drawing) and scanning an original copy positioned with an image to be read being directed upwardly under the bottom surface of the case (this type of scanners is advantageous because a user can check the original copy through the transparent top surface of the scanner.). The image reading device 1 typically has a size allowing for reading an original copy of postcard size, but it may be adapted to allow for reading an original copy of the size of paper of B5 and A4 or others. In this connection, though not shown, the inventive device may be of a type of a “handy scanner” in which a reading device is manually moved on an original copy to read an original image thereon. Further, a device which the present invention is applied to may be a type of acquiring the whole image on an original copy at one time.

On the top surface of the image reading device 1, there is provided an operation panel 4 including buttons, etc., allowing a user to provide commands to the image reading device or to select its operation or printing mode. On the operation panel 4, provided are Power button 100 for powering ON/OFF of a power source of the device 1; Start button 102 for commanding the device 1 to start the reading and printing of an image, Stop button 104 for commanding the device 1 to stop or cancel the reading and printing of an image, Digital display portion 108 which displays the printing number of sheets, an operation mode of the image reading device 1, layout mode, printing mode, etc., Selection switches 110a and 110b for changing the print number of sheets, selection of a layout, etc. and Setting change button 112 for changing a current setting in various setting items. Further, an alarm lamp for telling the abnormalities of a printer, the absence of modification parameters, etc. may be provided (not shown). As described in detail hereinbelow, various settings, those changing, and the start and stop of the operations commanded or selected by a user are all made on this operation panel.

As shown in FIG. 1A, printer 2 (typically, an ink-jet printer, but it may be of the other type) is directly connected to the image reading device 1 without interfaced with a PC. Printer 2 may be of any printer supporting a predetermined communication standard and, when receiving an image data, the printer 2 prints an image on a printing medium (not shown) in accordance with an internal own setting of the printer or a setting transmitted from the image reading device. The predetermined communication standard employed for the communication between the image reading device 1 and the printer 2 is typically “PictBridge” proposed for printing photographs with connecting a digital camera directly to a printer or a duplicator. However, the communication system or mode may be of the other type which enables communication between the image reading device 1 and printer 2. Moreover, in the illustrated example, the transmission and reception of signals between the image reading device 1 and the printer 2 are established with cable communication (USB etc.) through a cable 5, but wireless data transmission with Bluetooth (registered trademark) or an infrared light may be used. Furthermore, the image reading device 1 may be provided with means to memorize image data to a memory card (SD card etc.) 6. For a printer having the function of printing an image data memorized in a memory card, an image data may be transferred through the memory card. As described hereinbelow, a memory card may be used for acquiring the modification data associated with a printer into the image reading device.

Further, when the transmitting and receiving of signals between the image reading device 1 and printer 2 are made by means of the cable communication or the wireless communication, the inventive image reading device 1 preferably acquires, from the printer 2, its vendor name, vendor peculiar version, model name, product's number, etc. (called “identifying information” hereinbelow). In the case of PictBridge usable as a typical communication standard, a device or an apparatus connected to a printer can obtain the above-listed identifying information of the printer therefrom if a predetermined communication algorithm is incorporated in the device or apparatus. Thus, also in the inventive image reading device, any determined communication algorithm for obtaining the above-listed information is incorporated, and the acquired information regarding the printer 2 will be used as the identifying information of the printer (If the printer 2 can not output the identifying information, or if the image reading device 1 can not obtain the identifying information, the image reading device 1 will identify the printer 2 by other means or execute a printing operation with “no identifying information” as described later.

FIG. 1B shows the structure in the image reading device 1 in the form of a control block diagram. Referring to the drawing, the image reading device 1 includes CPU 10, a program memory 12, a work memory 14, an image memory 16, an operation panel 20, a USB control portion 22, and a scanner portion 24, all of which are mutually connected with a bidirectional common bus 26 as in a known image reading device. CPU 10 controls the operation of the image reading device 1 in the modes as explained in detail later, using the work memory 14 and other memories based on the system program memorized in the program memory 12. As understood from explanations described later, an image data generating portion, a printer identifying portion, an image modification processing portion and a modification data preparing portion in the inventive image reading device are realized through the operation of CPU 10 and the other parts therein.

The scanner portion 24 may be an image detecting device of a type well-known in the art, comprising an image sensor portion 24a (image detecting portion) which applies light on an original image to detect the reflected light therefrom, a motor and its control portion 24b which drive the image sensor portion to scan on an original copy. The light source and position of the image sensor portion 24a are controlled through an I/O portion 24c connected to the common bus 26 under control of CPU 10, and, analog image information signals detected in the image sensor portion are digitized in an A/D conversion portion 24d (image data generating portion), and the digitized image data is stored in the image memory 16. In this regard, the image data read in the scanner portion 24 may be modified in known ways, such as a shading compensation, a color modification, a gamma modification, and an MTF modification, in order to compensate various characteristics of the image sensor. (Information for compensating characteristics of the image sensor may be stored in a shading memory 28, which information may be used at any appropriate timing.)

The operation panels 20 is a panel, provided on the surface of an image reading device 1 as denoted with reference numeral 4 in FIG. 1A, including buttons for operation and a display. As noted, a user is allowed to give commands to the device 1 through the operation panel 20, and to confirm the operation modes of the device 1 and other settings.

As described above, the inventive image reading device 1 is connected with the printer 2 supporting the predetermined communication standard, and transmits an image data directly to the printer 2, enabling the printer to print an image. For such operations, in the inventive image reading device 1, a printer control code is generated from “an image data to be transmitted” in a manner adapted for the predetermined communication standard under the control of CPU 10. The printer control code will be further converted into a USB control code in the USB control portion 22 (image data outputting portion), and subsequently transmitted to the printer 2. Further, in obtaining identifying information from the printer 2, a signal indicating the identifying information may be received from the USB control portion 22. Then, the received signal is converted into a code processible by CPU 10, and stored in the work memory 14. Also, from the USB control portion 22 may be transmitted various control codes for printer's setting about dimensions and/or kinds of printing media or print papers, etc., and, if possible, codes for image quality or resolution of a printed image, in accordance with the predetermined communication standard. For a radio or wireless telecommunication system between the device 1 and the printer 2, the device may be provided with a radio outputting portion (not shown).

In addition, according to the inventive image reading device 1, an original image data which has been read and digitized in the scanner portion 24 is modified based upon modification data so as to be printed with a size or a layout desired or requested by a user on a printing medium. Thus, connected to the above-mentioned common bus 26 is a parameter memory 18 (modification data storage portion), memorizing modification data, parameters and/or other information about the internal setting of a printer required for performing the modification of an original image data (Hereinbelow, parameters for the modification of an image is referred to as “modification parameters”). As described in detail later, an individual modification data stored in the parameter memory 18 is associated with a certain printer.

Moreover, for executing the preparing of the modification data in the image reading device 1 (i.e. realizing a modification data preparing portion), the common bus 26 may be connected with a reference image data memory 19, in which a reference image data representing a reference image may be stored as usable appropriately under the control of CPU.

Still further, in order that an image data may be transferred using a memory card, the device 1 may be provided with a memory card drive 30. In this case, a memory card may be designed to store any image data generated in the device 1. Further, as described in “Summary of Invention”, when a modification data, prepared for a certain printer at the outside of the image reading device 1, are entered into the image reading device 1 and stored into the parameter memory, the memory card drive functions as a modification data receiving portion. In this case, new modification data are stored into a memory card at the outside of the image reading device. Then, the memory card is set into the drive 30 and the modification data in the memory card is transferred into the parameter memory 18.

Actual structures for transmitting various control codes, structure for wireless communication and/or a drive for memory cards may be provided in a manner known in the art. Further, optionally, a means for transmitting an image to a PC (not shown) may be provided as in the conventional image reading device.

### Modification of Image Data

As described above, the printer 2, directly connected to the inventive image reading device 1 and printing an image, is able to execute “margin-less printing” where an image is printed over the whole surface of a printing medium without leaving unfilled space in a periphery of the medium. In “margin-less printing” mode, the printer 2 prints an image represented by the received image data in a manner that the periphery of the image is printed out of a printing medium.

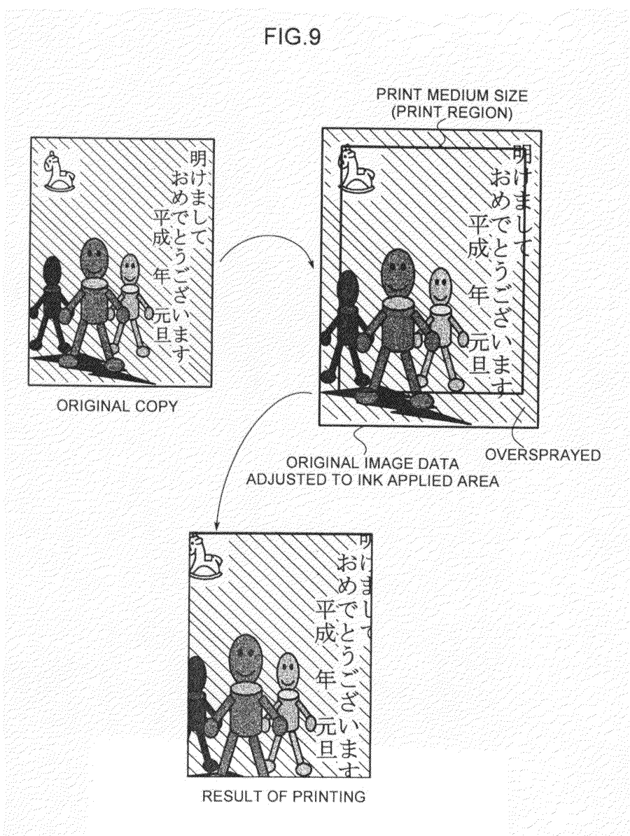

Referring to FIG. 9, for example, suppose that the image reading device 1 reads a region of postcard size, 148 mm long×100 mm wide, as shown in FIG. 9 upper left, at resolution of 300 DPI (the number of pixels per unit length) and generates the image data of 1748 [vertical]×1181 [horizontal] pix, where the size of one pixel of the image data corresponds to 0.085 mm on the original copy, and outputs this image data of the dimension as it is to the printer 2. Then, if the printer 2 operates in “margin-less printing” mode to print the image represented by the received image data on a printing medium of postcard size at the resolution 300 DPI, i.e., the same resolution as in the reading operation in an image reading device, the image of the image data of 1748×1181 pix is set to be 1.03 to 1.05 times larger in size than a printing medium, namely, the dimension of 1748×1181 pix is set to be magnified into 1800×1216 pix to 1835×1240 pix, resulting in that 3-5 mm of the periphery of the image represented by the received image data will extend beyond the printing medium (FIG. 9 upper right). Accordingly, the size of one pixel of the image data generated in the image reading device will be equivalent to 0.088-0.089 mm on a printing medium. Thus, even if the resolution (the number of dots of the ink deposited per unit length) in the printing is at 300 DPI, the resolution of the image data transmitted from the image reading device would be changed to about 291 to 285 DPI on a printing medium. Actually, in “margin-less printing”, since ink will be applied across the edge of the printing medium (overspray), the printing will be conducted without leaving unfilled space to the edge of the printing medium. And, the width of the periphery of the image extending from each edge of a printing medium and the size and position of a region within the image corresponding to the image data which actually appears on the printing medium cannot be adjusted by a user. As a result, the printed image of the image data obtained by reading an original image with the image reading device 1 and transmitted as it is therefrom, is different in size from the original image, and/or, cut off at the periphery as shown in the lower of FIG. 9, not as expected by a user. Moreover, the region which actually appears on a printing medium within the images corresponding to an image data varies with models of printers or paper settings.

However, it is known that, in “margin-less printing” of a typical printer, the periphery of an image extends beyond a printing medium at a certain determined width in each of the four directions of the medium irrespective of the dimension of a received image data. The width extending from the edge of a printing medium depends upon the size of the printing medium. For a sheet of postcard size, the extending width is normally about 3-5 mm. In other words, in “margin-less printing”, when the size of a printing medium is determined in a printer, an ink applied area is so determined as to extend beyond the printing medium at a certain predetermined width, and the dimension of a received image data is adjusted such that the size of an image corresponding to the received image data will coincide with an ink applied area. Thus, irrespective of the dimension of a transmitted image data, a dimension ratio and a position of a region actually appearing on a printing medium (a print region) in the transmitted image data are determined at the respective predetermined values in accordance with the internal setting of the printer. Accordingly, if the dimension ratio of an image data to be transmitted and the print region thereof and the shift of the central point between the transmitted image data and the print region are known for a printer or its model being used, the size and position of the print region in an image data of any arbitrary size are specified. Thus, in the inventive image reading device 1, an original image data to be transmitted to the printer 2 for its printing is modified, using the modification data prepared based upon the size and position of the print region (the region of the image printed on the printing medium) in an image data received by the printer 2, such that the original image data transmitted to and printed with the printer 2 will be printed in a size or with a layout desired by a user on a printing medium set in the printer 2 while the periphery of the image is not unexpectedly cut off as shown in the bottom of FIG. 9.

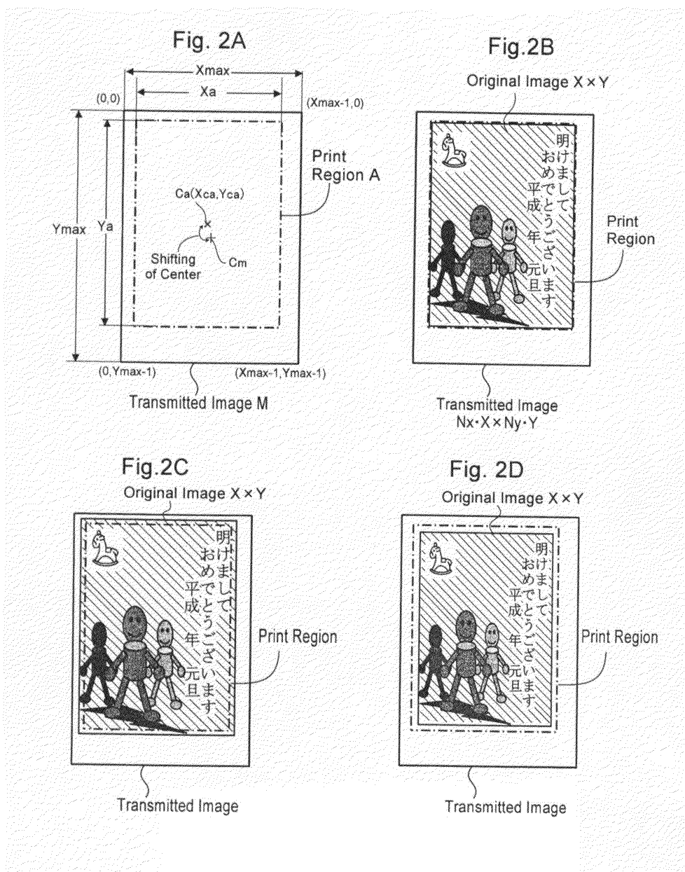

In modifying an original image data, practically, the dimension ratios Nx, Ny (referred to as “scaling factor”, hereinbelow) in X and Y directions between an image data M transmitted to the printer and its print region A and the shift between the center Cm of the image data and the center Ca of the print region A (referred to as “shifting mounts” Sx, Sy, hereinbelow) as shown in FIG. 2A are employed for the modification parameters (modification data).

Referring to FIG. 2A, suppose that the dimensions of the image data M received by a printer are Xmax×Ymax (the unit is the number of pixels) and the dimensions of a print region actually printed on a printing medium in the printer are Xa33 Ya, the scaling factors Nx and Ny in X and Y directions are given by

Nx=Xmax/Xa

Ny=Ymax/Ya.

When the widths of the peripheral portions of the image data M extending beyond the edge of the printing medium are not equal between the upper and lower sides or between the left and right sides, the center Ca of the print region A and the center Cm of the image data M do not coincide with one another, and therefore the shifting amounts Sx and Sy are given by:

Sx=Xca−Xmax/2

Sy=Yca−Ymax/2.

### (In Japanese Patent Application 2006-178606, as the shifting amounts are defined on a printed image, the shift amounts are the values of the above formula multiplied by the scaling factor.)

Thus, in order to print an original image data of size X×Y read and generated by the image reading device in conformity with the entire region of an printing medium, as shown in FIG. 2B, the original image data is to be coincided with the print region of the image data transmitted to the printer, and therefore, the original image data will be pasted on or allocated to the transmitting image data having the entire size set to Nx·X×Ny·Y, while the center of the former is shifted by the shifting amounts Sx and Sy from the center of the latter, rendering the original image data to fit into the print region of the transmitted image data. This transmitted image data incorporating the original image data therein is a modified original image data. The printer, when receiving the modified original image data, will print the print region coincidentally with the printing medium, thereby printing the original image without cutting off the peripheral portions thereof on the printing medium. Further, in order to render the entire region of an original image data of size of X×Y to extend beyond a printing medium by a predetermined amount or in order to make an original image data smaller than the print medium to provide margins around the image on the print medium, an image data into which the original image data is fit may be prepared such that the size of the original image data (or the image data to be printed on the printing medium) is made larger (FIG. 2C) or smaller (FIG. 2D) than that the print region of the transmitted image data, and the resultant image data may be transmitted to the printer. In these cases, the size and position of the original image data (or the image data to be printed on the printing medium) in the image data to be transmitted (the modified original image data) also can be determined by using the scaling factors Nx, Ny and shifting amounts Sx, Sy.

In this regard, although the scaling factors are defined separately for X and Y directions in the above, a common scaling factor N may be used for both X and Y directions in the case that the aspect ratio of a received image data is not changed in the printing by the printer, because the scaling factors Nx and Ny become equal to one another. Further, if the centers of the transmitted image data and the print region coincide with one another or if the shifting of those centers may not be minded, the shifting amounts Sx, Sy need not be used. Whether the different scaling factors are used for X and Y directions or not, and whether the shifting amounts are used or not, may be arbitrarily selected by a user. Furthermore, if the size of an image data transmitted from the image reading device to a printer is fixed, coordinates specifying the range of the print region in the transmitted image data may be used as modification parameters, instead of the use of the scaling factors and/or shifting amounts described above. In this case, an original image data or an image data to be printed on a printing medium may be fit into the print region in the transmitted image data specified by the coordinates.

The image modification processing portion for executing the modification of an image as described above is realized by the operation of CPU and the related portions. It should be understood that the processing of images for the above-mentioned modification of images, i.e. enlargement or contraction of the image data or pasting of the image data, may be done by any method convenient for a user. The modification processing is executed in the “normal mode” described later.

### Preparation of Modification Parameters

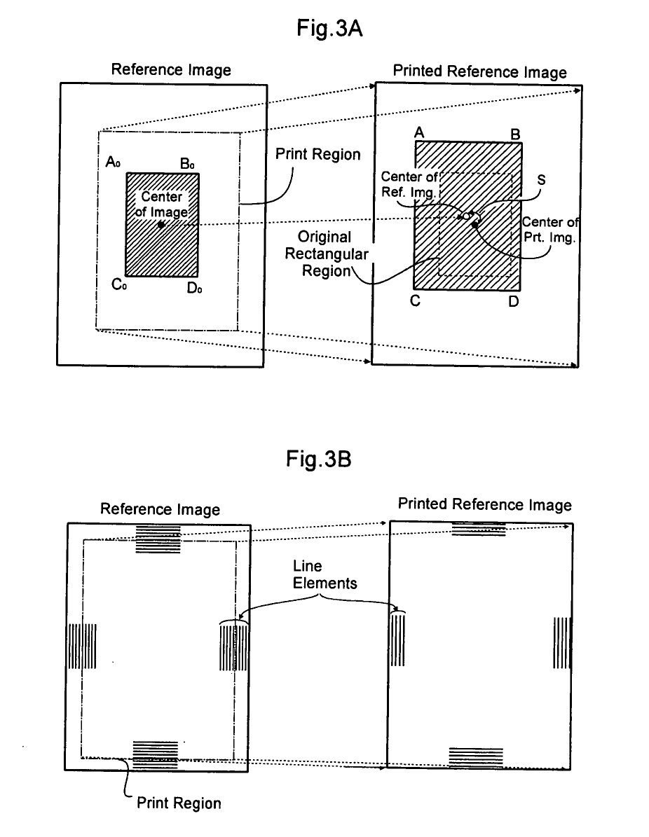

As will be understood from the above-mentioned descriptions, modification parameters used as the modification data, such as the scaling factors and shifting amounts or the coordinates specifying the range of a print region, can be determined based upon the size and/or position of a print region in an image data received by a printer. Since a received image data in a normal printer is printed at the number of pixels per unit length which is approximately uniform on a print medium although the aspect ratio of the image may be changed in some cases, the modification parameters can be determined by detecting or analyzing in what size or at what position an image within a transmitted image data is printed without detecting the size or position of the print region. For instance, the above-mentioned scaling factors Nx, Ny and shifting amounts Sx, Sy can be obtained by providing a reference image data representing a reference image including a predetermined pattern such as exemplarily shown in FIG. 3A or 3B to a printer, printing the image of the reference image data, and comparing the printed image with the reference image. In the case of FIG. 3A, from the ratio α of the size of the rectangular area, AoBoCoDo, in the reference image to the overall size of the reference image, and the ratio β of the size of the rectangular area ABCD in the printed image to the overall size of the printed image, the scaling factor is given by: N=α/β. In the case of FIG. 3B, from the difference in the number of the line elements in the peripheral portions of the reference image and the printed image, the widths of the respective peripheral portions of the image data extending beyond the corresponding edges of the printing medium are calculated, and thereby the range of the print region can be known.

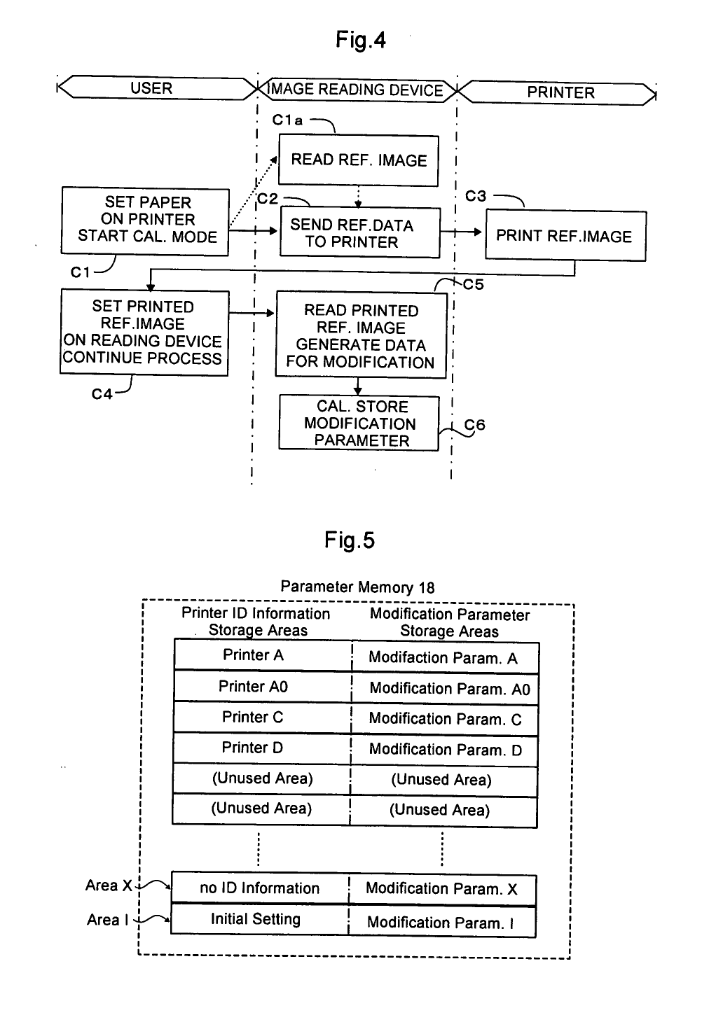

The preparation of the above-mentioned modification parameters may be executed in any arbitrary method at the outside of the image reading device 1, or may be executed by using the image reading device 1. For the preparation of the modification parameters within the image reading device 1, a modification data preparing portion is established in CPU 10 and the other portions. Upon the preparation of the modification parameters in the image reading device 1, the printer 2 is connected to the image reading device 1, i.e. the printer 2 is rendered to be capable of printing the image data transmitted from the image reading device 1, and then, the preparation of the modification parameters may be executed according to the process exemplarily shown in FIG. 4. This operation mode of the image reading device 1 for preparing the modification parameters is called “calibration mode”, hereinbelow (the same as in the case of Japanese Patent Application 2006-178606).

Referring to FIG. 4, when the start of operation in the calibration mode is requested by a user through the operation panel 20 (C1), a reference image data is transmitted to the printer 2 from the image reading device 1 (C2), and the printing of a reference image is conducted (C3). Preferably, the reference image data is memorized in advance in a reference image data memory 19 connected with the common bus 26 so that the image data may be drawn out of the reference image data memory 19 when the printing of the reference image is requested. In this regard, instead of the storing of the reference image data in the memory 19, the reference image data may be generated at the staring of the calibration mode by reading a reference image drawn on a paper sheet or other medium. In that case, the operation of C1a will be required.

Then, when the printing of the reference image is completed, the user sets the printed image of the reference image to the image reading device 1 (C4), and provides a command of continuation of processing through the operation panel. In response to the user's command, the image reading device 1 starts reading the printed image of the reference image, and generates an “image data for modification” (C5), and then, modification parameters used for the printer are computed from the image data for modification (C6) through the comparison and analysis of the image data for modification (the printed image of the reference image) and the reference image.

In the case that the preparation of the modification parameters is executed at the outside of the image reading device 1, modification parameters can be prepared by letting the printer 2 print the reference image and by analyzing the result of the printing. However, in this case, the transmission of the reference image data to the printer and the analysis of the printed image of the reference image may be performed by devices other than the image reading device 1.

It should be understood that the image processing for the preparation of the modification parameters, i.e., the detection of a predetermined pattern image, the calculation of its size, the computation of the scaling factors, shifting amounts, etc. may be conducted in accordance with any methods known for those skilled in the art.

### Record, Store and Deletion of Modification Parameters

As briefly mentioned in the above, modification parameters used as modification data are recorded or stored in the parameter memory 18 while the respective sets of the modification parameters are associated with the corresponding printers. To do this, in the parameter memory 18, there are provided printer information storage areas and modification parameter storage areas as diagrammatically shown in FIG. 5, in which a plurality of values of modification parameters are stored while associated with the identifying information of the corresponding printers. In the case that the modification parameters are prepared by the image reading device 1, the identifying information acquired from a printer connected to the image reading device is stored in one of the printer information storage areas, and, after the preparation of the modification parameters for the printer, the resultant modification parameters are stored while being associated with the identifying information of the corresponding printer into one of the modification parameter storage area. On the other hand, in the case that the modification parameters prepared at the outside of the image reading device 1 are entered into the image reading device 1, a memory card, which memorizes the modification parameters associated with the identifying information of a printer in a manner readable with the drive 30, is prepared. Then, when the memory card is set into the drive 30, the identifying information of the printer and the modification parameters associated therewith are transmitted to unused areas in the printer information storage areas and the modification parameter storage areas, respectively. In this connection, various sets of identifying information and modification parameters for printers may be stored in the manufacturing of the image reading device 1.

The printer identifying information associated with the modification data and stored in the memory may typically be the model name of a printer. As already noted, in most of the printers generally distributed in the market, the sizes and positions of print regions in image data transmitted to the printers are common for the same model of printers so that the same modification parameters can be used in modifying image data. Thus, in storing the identifying information of a printer in the parameter memory, the model name of the printer or a signal or sign expressing the model thereof may be stored in one of the printer information storage areas and the modification parameters may be stored for each of the models of printers. However, the modification parameters may be stored for individual printers, instead for model type of printers. In this case, the individual product number or serial number particular to each printers may be used as the identifying information. This manner may be used for the case that the modification of an image could not be satisfactorily performed by means of the modification parameters prepared for the model of a printer being used because of individual variances in the settings of the printer upon their manufacture or aged variances of the condition of the printer during its use.

Further, in addition to the printer identifying information and the modification parameters associated therewith as described above, modification parameters associated with no printer identifying information may be provided in at least one of storage areas as exemplarily shown in FIG. 5. One of the storage areas for modification parameters associated with no printer identifying information (“X” in FIG. 5) is for storing modification parameters for a printer of which no identifying information is acquirable. The data stored in the modification data storage area X is rewritable arbitrarily. For example, upon preparing the modification parameters for a certain printer in the image reading device 1 in accordance with a method as described in the above-mentioned “Preparation of Modification Parameters”, if the identifying information of the printer is unknown, the prepared modification parameters will be stored in the storage area X. Further, another storage area for modification parameters associated with no printer identifying information (“I” in FIG. 5) is for storing “initial” modification parameters, which will be used for the modification of an image data without the preparation of the modification parameters when the parameter memory does not contain modification parameters for a printer to be used. The “initial” modification parameters may be used regardless of the availability of the printer identifying information. The values of the initial modification parameters may be standard value (such as mean value, for example) determined by referring to the modification parameters for the printers available in the market.

Upon newly storing identifying information of a printer and modification parameters associated therewith in the parameter memory, if the amount of data stored in the parameter memory exceeds a predetermined value and the remaining capacity of the parameter memory has decreased so that no more data can be stored, it is preferable that a part of the already stored modification data is deleted in order to enable storing the identifying information of a printer and modification parameters associated therewith to be newly stored. The information and parameters of the printer to be deleted may be selected by a user, but, alternatively, may be selected automatically. In the automatic selection of the data to be deleted, first, there are taken into account the group of the modification data for printers of which the respective orders of the last time of connection to the image reading device, counted from the oldest one, is within the number being at a predetermined ratio for the total number of all the stored data set. For example, suppose that the number of “k” of sets of the modification parameters are stored, the data to be taken into account here are from “the data for the printer of which the last time of the connection is the oldest” to the “data for the printer of which the order of the last time of the connection counted from the oldest one corresponds to the number of r×k”, where “r” is the predetermined ratio, smaller than 1 such as 0.25. Then, among the data in the group, the modification data for the printer of which the number of the frequencies of connection to the image reading device is the least will be selected automatically for the data to be deleted. In this case, the parameter memory is provided with areas for recording the orders of the last time of the connection and the number of frequencies of the connection to the image reading device for the respective printers (not shown). The orders of the last time of the connection for the respective printers may be determined by measuring the date and time of their connections by means of a clock provided in the image reading device. Alternatively, it may be designed such that, every time a certain printer is connected to the image reading device, the orders of the times of the last connections for the respective printers may be updated while counting the number of the frequencies of the connection for the currently connected printer. The updating of the orders of the last time of the connection of the printers may be done, for example, by assigning the number “1” to the currently connected printer while the numbers of the orders for the rest of the printers are increased by “1” at each time the connection of one of the printers to the image reading device is formed. However, the orders of the modification parameters may be assigned in any other manner.

It should be understood that the signal processing for the storage or saving of the printer identifying information and the modification parameters into the parameter memory, and the deleting of the data from the memory can be done by any method available for those skilled in the art.

### Operation of Image Reading Device

The image reading device 1 operates selectively in the “calibration mode” to prepare the modification parameters as described above and in the “normal mode” to read and print an original image. In this regard, just after putting on the electric power, the image reading device 1 may be set up in the normal mode. The operation of the calibration mode is carried out only when instructed by a user through the operation panel 20 (4 in FIG. 1A).

In the normal mode, in general, the reading of an original image and the generating of the image data thereof are executed together with the acquisition of the identifying information of printer 2 connected to the image reading device 1. Then, the original image data is modified by using the modification parameters selected in accordance with the printer identifying information, and thereby a modified original image data is generated. Thereafter, the modified original image data is transmitted from the image data output portion to the printer 2, and the printing of the image is executed. As already described, since the image data to be printed on a printing medium is pasted into the print region of the modified original image data (refer to FIG. 2 B -2D), the image will be printed in the size or with the layout desired by the user.

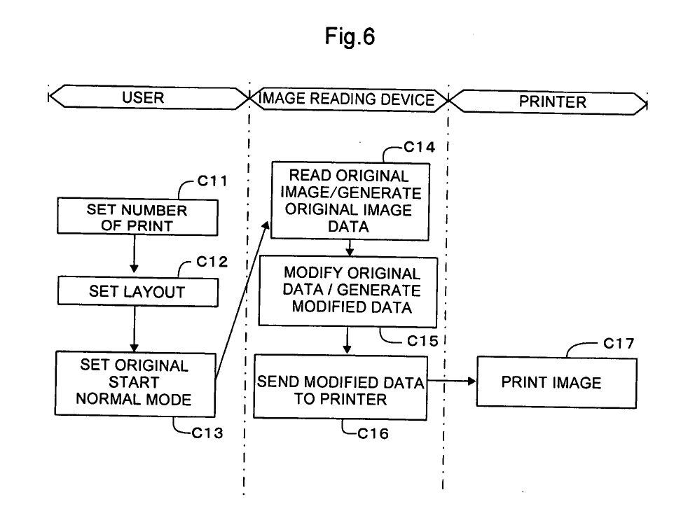

FIG. 6 shows the operations of a user, the image reading device and a printer in the normal mode. Referring to FIG. 6, first, the user sets an original copy in the image reading device 1, and requests the start of operation in the normal mode through the operation panel 20 (C13). Before this operation, the setting of the number of the printing (C11) and the selection of a layout of the image on a printing medium (C12) may be conducted by the user. In the selection of a layout, the user selects the position or size of the image on the printing medium through the operation panel. The image may be printed on the printing medium in a mode as illustrated in FIGS. 2 B-2D or the other arbitrary layout (such as a layout in which the original image is arranged on multiple sites on the printing medium). In this regard, as a default setting, the printing number may be set to one, and for a default layout, the mode as shown in FIG. 2B, where the whole original image is printed in conformity with the whole area of a printing medium, may have been set up. Then, when the command of the operation start of the normal mode is given, the image reading device 1 reads an original image, and generates an original image data (C14). Next, in order to print the original image on the printing medium with the selected layout, the original image data is modified by means of modification parameters to generate a modified original image data (C15), and the resultant modified image data is transmitted to the printer 2(C16). The printer 2, when receiving the modified original image data, will print an image according to an internal setting of the printer (C17).

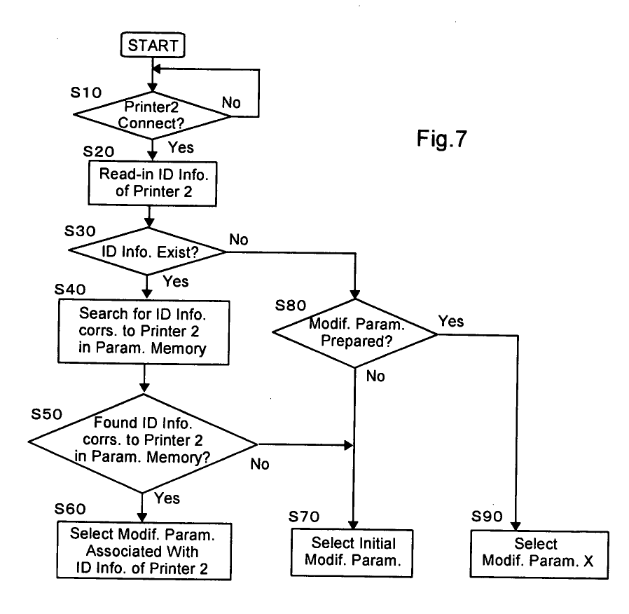

The modification parameters used in C15 are selected in accordance with, for example, the processes described in FIG. 7 as shown in the form of a flowchart. Referring to the figure, first, it is judged if the printer 2 is connected or not, i.e. if the condition that an image data is transmittable from the image data output portion (the USB control portion) to the printer 2 is established (step 10). If it is judged that the printer 2 is not connected, the image reading device 1 generates a warning signal for the user while getting into a stand-by state. On the other hand, when the connection with the printer 2 is judged, the process for acquiring the identifying information of the printer 2 is executed (step 20). The identifying information is typically acquired from the printer 2 through cable or wireless communication. However, it may be designed such that the user can input any identifying information or select it from the information having been inputted for printers of which the modification parameters have been stored in the parameter memory. If the image reading device is designed to acquire the identifying information only through the cable or wireless communication with the printer 2 and if the printer 2 does not output the identifying information, the process for the case of “no identifying information (unknown)” will executed thereafter.

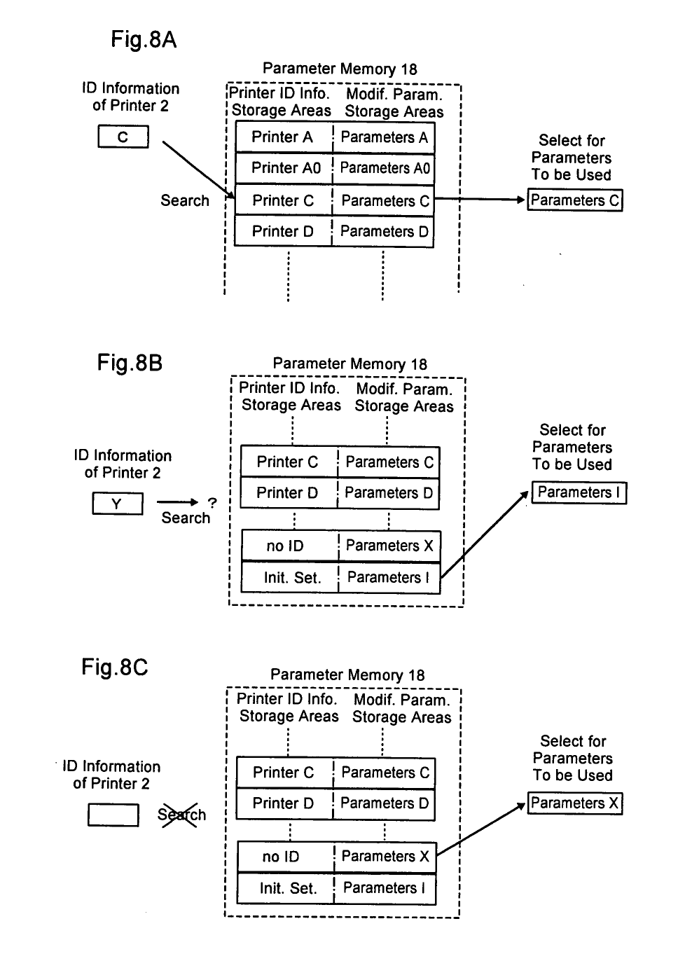

After the execution of the process of acquiring the identifying information, it is judged if the identifying formation has been acquired (step 30). If the identifying information is acquired, then a retrieval process is performed to search a set of the identifying information coinciding with the identifying information obtained in this time and the modification parameters associated therewith in the parameter money (step 40). When the identifying information and the corresponding modification parameters are found in the parameter memory (step 50), the modification parameters are selected to be used for the modification of an image data (step 60). For instance, as illustrated in FIG. 8A, if the identifying information of the connected printer 2 is C and the identifying information coinciding therewith exists in the parameter memory, then, the modification parameters C will be selected. However, when the identifying information coinciding with the identifying information obtained in this time is not found in step 50, for instance, when the identifying information of the printer 2 is “Y” and the identifying information coinciding therewith is not found as illustrated in FIG. 8B, the initial modification parameters I are set for the modification parameters to be used (step 70). In this connection, when modification parameters are found, the total frequencies of connection between the image reading device and the whole of printers, and the frequencies of connection of the printer of the identifying information selected currently may be recorded. These data regarding the frequencies of connection will be used upon deleting the data in the parameter memory, as described above. On the operation panel, whether or not the appropriate modification parameters are found may be shown.

On the other hand, when the identifying information is not obtained from the connected printer in step 30 and the judgment of “no identifying information” is made, the modification parameters “X” is set for the modification parameters (step 90, see FIG. 8C). As noted, the modification parameter storage area X is capable of storing the values obtained by the above-mentioned preparation of the modification parameters for the case that the identifying information of the printer is not acquirable. Consequently, even in the case that the identifying information can not be obtained, if the user has once executed the preparation of the modification parameters for the printer, no preparation operation is required for the printer thereafter. In this connection, the inventive image reading device may be designed such that the initial modification parameters I may be selected as the modification parameters by the selection of the user for the case that the identifying information can not be obtained (For example, step 80 may be inserted for letting the user select whether or not the preparation of the modification parameters of the printer has been executed in the past in the case of the “no identifying information”.). For example, for a printer which has never been connected to the image reading device and of which the identifying information is not available, if it is known that the printer is different from another printer associated with the already stored modification parameters X, it may be expected that the initial modification parameters I produces better printing results than the modification parameters X. In this regard, on the operation panel, it may be so shown when the modification parameters X or the initial modification parameters I are set to the modification parameters.

Further, in the above-mentioned step 50 or 80, if it is judged that the modification parameters associated with the printer 2 do not exist in the parameter memory, it may be so designed that the operation in the normal mode is ceased to interrupt the printing of the image in accordance with the selection by the user. In the case that the operation of the normal mode is stopped and the printing of the image is interrupted, appropriate modification parameters associated with the printer 2 may be prepared through the execution of the above-mentioned calibration mode, and then, in the restart of the normal mode operation, the printing can be done based upon the appropriately modified original image data.

Thus, according to the selection process of modification parameters as shown in FIG. 7, if the modification parameters associated with the printer 2 exist in the parameter memory, the selection of appropriate modification parameters associated with the printer 2 and the modification of an image data will be executed without preparing the modification parameters. Further, even in the case that no modification parameters associated with the printer 2 exist in the parameter memory, through the preparation of the modification parameters once, no preparation of the modification parameters is required thereafter. In this regard, the setup of the modification parameters in FIG. 7 may be executed before starting the normal mode operation (before the user pressing the start button), or may be done during executing the processing of C15 of FIG. 6.

In the case that an image data is transmitted to a printer with a memory card, the printer identifying information for selecting the modification parameters may be manually input to the image reading device 1, or the identifying information already existing in the parameter memory may be selected and the modification parameters associated with the identifying information are used for the modification of an image data. In this case, it may be judged in step 10 if a memory card is set into the drive 30.

1. An image reading device for reading an image, generating and outputting an image data representing the image, the device comprising:
an image detecting portion which optically reads an original image on an original copy and generates a signal representing the original image;
an image data generating portion which generates an original image data based on the signal representing the original image;
an image data outputting portion which outputs an image data with a communication mode which enables a printer supporting a predetermined communication standard to receive the image data and to print an image represented by the image data; and
a printer identifying portion which identifies a printer set capable of receiving the original image data from the image data output portion.
a modification data storage portion which stores modification data for modifying the original image data, the modification data being associated with a printer identifiable by the printer identifying portion and prepared based upon a size and/or a position of an image to be printed on a printing medium by the identifiable printer within an image data received by the identified printer
an image modifying portion which modify the original image data based upon the modification data associated with the printer identified by the printer identifying portion,
wherein the image data outputting portion selectively outputs a modified original image data generated by modifying the original image data with the image modification processing portion to render a printed image corresponding to the original image to be printed in a desired size or with a desired layout on a printing medium.

2. An image reading device according to claim 1, wherein the printer identifying portion identifies the printer set capable of receiving the image data from the image data output portion in accordance with a model of the printer.

3. An image reading device according to claim 1, wherein the printer identifying portion identifies the printer set capable of receiving the image data from the image data output portion in accordance with a product serial number of the printer.

4. An image reading device according to claim 1, further comprising a modification data preparing portion which prepares a modification data associated with the printer set capable of receiving the image data based upon an image data for modification generated with the image data generating portion through reading a printed reference image with the image detecting portion, the printed reference image being printed on a printing medium with the printer set capable of receiving the image data to which printer a reference image data representing a reference image including a predetermined pattern is outputted from the image data outputting portion; and wherein the modification data prepared by the modification data preparing portion is stored in the modification data storage portion while the modification data is associated with the printer set capable of receiving the image data.

5. An image reading device according to claim 4, wherein the modification data storage portion has an area for storing a modification data associated with no particular printer, and when the printer set capable of receiving the image data is not identifiable by the printer identifying portion, the modification data prepared by the modification data preparing portion is stored in said area for storing a modification data associated with no particular printer.

6. An image reading device according to claim 1, wherein the modification data storage portion stores a modification data prepared for a printer at an outside of the image reading device.

7. An image reading device according to claim 1, further comprising a modification data receiving portion which receives a modification data prepared for a printer at the outside of the image reading device, wherein the modification data storage portion stores the modification data prepared at an outside of the image reading device.

8. An image reading device according to claim 1, wherein when a new modification data is to be stored in a condition that the amount of data stored in the modification data storage portion is in excess of a predetermined amount, a part of the modification data already stored is deleted.

9. An image reading device according to claim 8, wherein, upon deleting the part of the modification data already stored, the modification data, associated with a printer of which the number of frequencies of connection to the image reading device is the least among modification data for printers of which respective orders of a time of a last connection to the image reading device, counted from the oldest one, are within the number being at a predetermined ratio for a total number of all of the stored modification data, is deleted.

10. An image reading device according to claim 1, wherein the modification data storage portion stores an initial modification data associated with no particular printer, and the image modification processing portion selectively modifies the original image data based upon the initial modification data.
